(19) United States
(12) Patent Application Publication
(10) Pub. No.: US 2016/0334063 A1
(43) Pub. Date: Nov. 17, 2016

(54) Portable air tank

(71) Applicants: Chung Wei Huang, Taichung (TW); Wen-Hung Li, Taichung (TW); Cheng Yu Huang, Taichung (TW)

(72) Inventors: Chung Wei Huang, Taichung (TW); Wen-Hung Li, Taichung (TW); Cheng Yu Huang, Taichung (TW)

(21) Appl. No.: 15/219,277

(22) Filed: Jul. 26, 2016

(51) Int. Cl. F17C 13/06; F17C 1/00

(52) U.S. Cl. CPC F17C 13/06; F17C 1/00; F17C 2201/0119; F17C 2201/032; F17C 2201/058; F17C 2205/0311; F17C 2221/031

(57) ABSTRACT

A portable air tank includes a reservoir including a space for containing compressed air, an upper neck, a channel through the neck, internal threads on a surface of the channel, external threads on an outer surface of the neck, and an annular bottom in the channel; a communication member in the channel and including a stem, a tunnel in the stem, and an annular member on a bottom of the stem and rested on the annular bottom; a sealing ring rested on the annular member; and a cap including an axial hole for receiving the stem, external threads secured to the internal threads to urge the annular member against the annular bottom for airtight purposes, and a top handle member.

### BACKGROUND OF THE INVENTION

1. Field of the Invention

The invention relates to air tanks and more particularly to a portable air tank having improved airtight characteristics.

2. Description of Related Art

A conventional portable air tank for paintball guns, bicycles, motorcycles, and automobiles is shown in FIG. 4 and includes a reservoir 50 filled with compressed air and having a neck 51, a top space 52, and an inwardly extending rim 53 on a top; a communication member 60 in the space 52 and having a top sealing member 61; and a sealing ring 70 in an annular groove of the communication member 60 and compressed by an internal surface of the neck 51 for preventing compressed air in the reservoir 50 from leaking through a joining portion of the communication member 60 and the neck 51. The communication member 60 is fastened by the rim 53.

The rim 53 is a thin member and liable to bend or even break. Thus, the fastening of the communication member 60 is not reliable. Moreover, the sealing ring 70 is structurally strong to prevent the compressed air from passing its surface. Thus, air leakage may occur after a short period of time of use.

Thus, the need for improvement still exists.

### SUMMARY OF THE INVENTION

It is therefore one object of the invention to provide a portable air tank comprising a reservoir including a space for containing compressed air, an upper neck, a channel through the neck, internal threads on a surface of the channel, external threads on an outer surface of the neck, and an annular bottom in the channel; a communication member in the channel and including a stem, a tunnel in the stem, and an annular member on a bottom of the stem and rested on the bottom; a sealing ring rested on the annular member; and a cap including an axial hole for receiving the stem, external threads secured to the internal threads to urge the annular member against the bottom, and a top handle member.

The above and other objects, features and advantages of the invention will become apparent from the following detailed description taken with the accompanying drawings.

### BRIEF DESCRIPTION OF THE DRAWINGS

FIG. 1 is a perspective view of a portable air tank according to the invention;

FIG. 2 is an exploded view of the portable air tank;

FIG. 3 is a longitudinal sectional view of the portable air tank; and

FIG. 4 is a longitudinal sectional view of a conventional portable air tank.

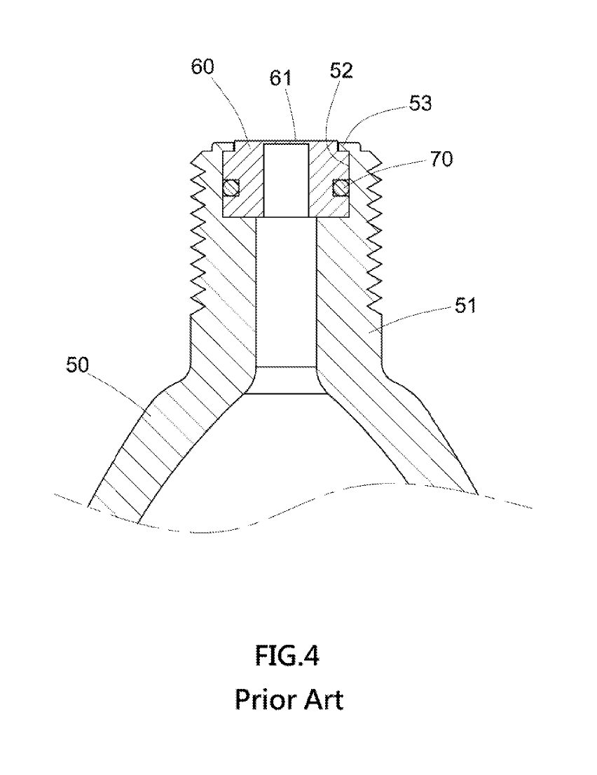

### DETAILED DESCRIPTION OF THE INVENTION

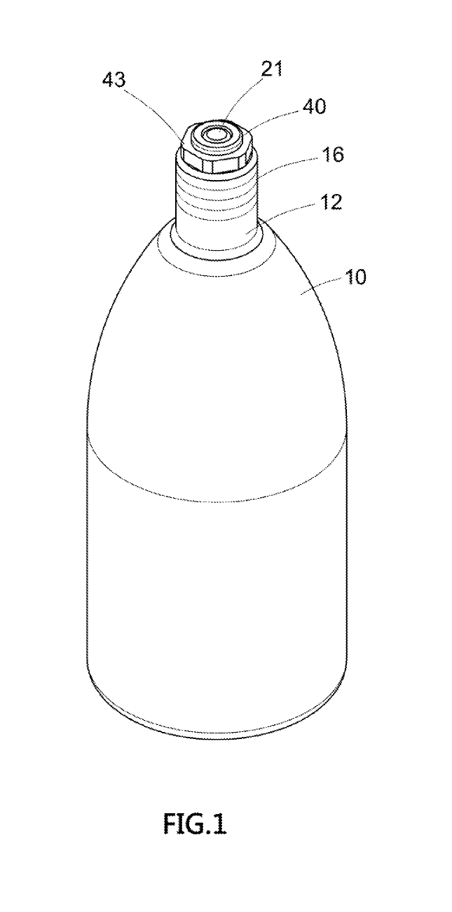

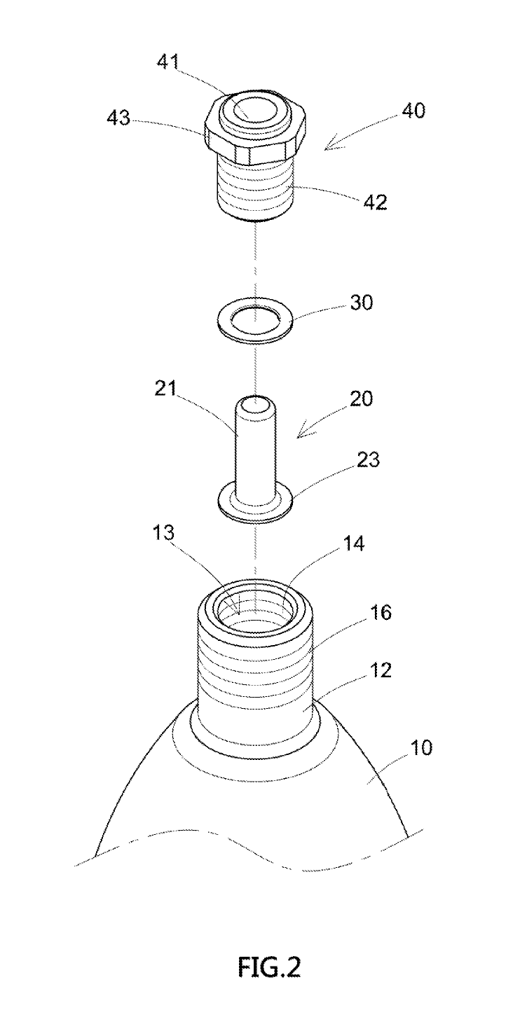

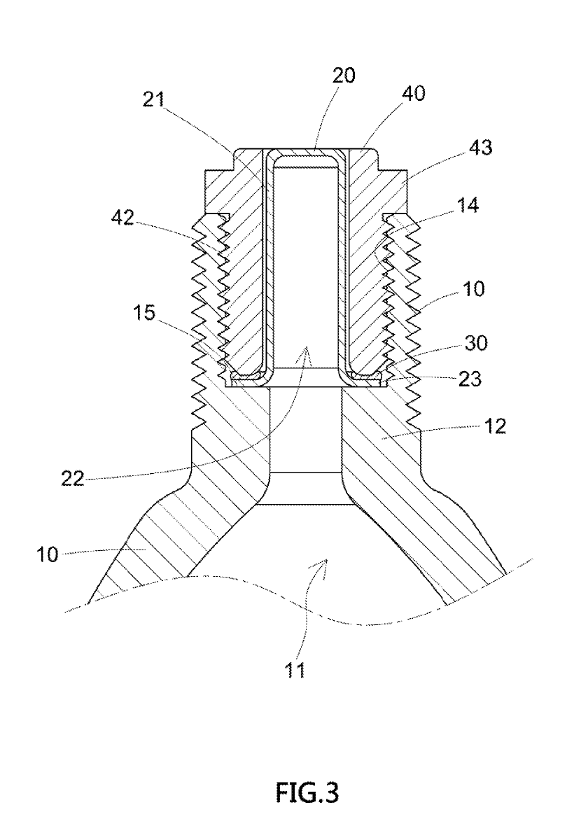

Referring to FIGS. 1 to 3, a portable air tank in accordance with the invention comprises a reservoir 10 including a space 11 for containing compressed air, an upper neck 12, a channel 13 through the neck 12, internal threads 14 on a surface of the channel 13, external threads 16 on an outer surface of the neck 12, and an annular bottom 15 in the channel 13; a communication member 20 in the channel 13 and including a stem 21, a tunnel 22 in the stem 21, and an annular member 23 on a bottom of the stem 21 and rested on the bottom 15; a sealing ring 30 rested on the annular member 23; and a cap 40 including an axial hole 41 for receiving the stem 21, external threads 42 secured to the internal threads 14 to urge the sealing ring 30 against the annular member 23 which urges against the bottom 15 for airtight sealing, and a hexagonal handle member 43 on a top. A person may put a tool on the handle member 43 to fasten or unfasten the cap 40.

In use, a person may use a pointed member to pierce the thin top of the stem 21. As a result, compressed air in the reservoir 10 exits via the tunnel 22.

While the invention has been described in terms of preferred embodiments, those skilled in the art will recognize that the invention can be practiced with modifications within the spirit and scope of the appended claims.

What is claimed is:

1. A portable air tank comprising:
a reservoir for containing compressed air and including an externally threaded neck and an internally threaded channel through the neck;
a communication member in the channel and including a stem, a tunnel in the stem, and an annular member on a bottom of the stem;
a threaded cap fastened in the channel and including a top handle member and an axial hole for receiving the stem; and
a sealing ring urging against the annular member which urges against a bottom of the channel.
